(19) United States
(12) Patent Application Publication
(10) Pub. No.: US 2011/0315909 A1
(43) Pub. Date: Dec. 29, 2011

(54) CONSTANT-RESIDUAL-PRESSURE VALVE

(75) Inventors: Shinobu OIKAWA, Kariya-city (JP); Hirokuni Tomita, Okazaki-city (JP)

(73) Assignees: NIPPON SOKEN, INC., Nishio-city (JP); DENSO CORPORATION, Kariya-city (JP)

(21) Appl. No.: 13/171,917

(22) Filed: Jun. 29, 2011

(30) Foreign Application Priority Data
Jun. 29, 2010 (JP) 2010-147600

(51) Int. Cl. F16K 27/02

(52) U.S. Cl. 251/337; 251/336

(57) ABSTRACT

A constant-residual-pressure valve is disposed in a communication passage connecting a high-pressure fuel passage through which pressurized fuel flows with a low-pressure fuel passage through which the fuel flows toward a high-pressure pump. The constant-residual-pressure valve includes a valve body, a spring, and a spring stopper. The valve body can sit on a valve seat formed in an inner passage. The spring biases the valve body toward the valve seat. The spring stopper has a downstream-orifice of which flow passage area is smaller than that of a passage upstream of the valve seat. Thereby, cavitation between the valve body and the valve seat is less generated.

### CROSS-REFERENCE TO RELATED APPLICATION

This application is based on Japanese Patent Application No.2010-147600 filed on Jun. 29, 2010, the disclosure of which is incorporated herein by reference.

### FIELD OF THE INVENTION

The present invention relates to a constant-residual-pressure valve which is applied to a fuel supply system of a direct injection engine.

### BACKGROUND OF THE INVENTION

Conventionally, a fuel supply system which supplies fuel to a direct injection engine is equipped with a high-pressure pump for pressurizing the fuel. The fuel discharged from the high-pressure pump is accumulated in a delivery pipe and is injected to a cylinder through an injector.

JP-2009-121395A (WO-2009/063306A1) shows a constant-residual-pressure valve which is disposed in a fuel passage connecting a pressurization chamber of the high-pressure pump and a delivery pipe. When a differential fuel pressure between the delivery pipe and the pressurization chamber exceeds a specified pressure, the constant-residual-pressure valve is opened to allow a fuel flow from the delivery pipe to the pressurization chamber.

This constant-residual-pressure valve has a valve body, a valve seat, and an orifice which determines a fuel flow rate flowing from the delivery pipe to the pressurization chamber. The orifice is arranged upstream of the valve seat. When the constant-residual-pressure valve is opened, a clearance is slightly generated between the valve body and the valve seat. The velocity of the fuel flowing through the clearance is increased. The fuel pressure becomes lower than the saturated vapor pressure, whereby cavitation occurs. Such cavitation generates strong impact, noise, and vibration. It is likely that the valve body and the valve seat are damaged due to the cavitation corrosion (erosion corrosion). If the valve body and the valve seat are damaged due to the cavitation corrosion, the oil-tightness between the valve body and the valve seat may be deteriorated, so that a pressure holding performance of the constant-residual-pressure valve may be also deteriorated.

If the pressure holding performance of the constant-residual-pressure valve is deteriorated, the fuel pressure in the delivery pipe is decreased lower than a predetermined pressure after the engine is stopped. An evaporation temperature of fuel is also decreased along with the fuel pressure drop. Further, the fuel temperature in the delivery pipe rises due to temperature rise in the engine room. Thus, if the fuel temperature in the delivery pipe exceeds the evaporation temperature, vapors may be generated in the delivery pipe. Such vapors may deteriorate a high-pressure pump characteristic and engine startability.

### SUMMARY OF THE INVENTION

The present invention is made in view of the above matters, and it is an object of the present invention to provide a constant-residual-pressure valve capable of maintaining a pressure holding performance.

According to the present invention, a constant-residual-pressure valve is disposed in a communication passage connecting a high-pressure fuel passage through which pressurized fuel flows with a low-pressure fuel passage through which the fuel flows toward a high-pressure pump. The constant-residual-pressure valve includes a valve body, a biasing member and a downstream-orifice. The valve body is capable of sitting on a valve seat formed on an inner wall surface of the communication passage. The valve body prohibits a fuel flow from the low-pressure fuel passage to the high-pressure fuel passage in a case that the valve body sits on the valve seat. The valve body allows a fuel-flow from the high-pressure fuel passage to the low-pressure fuel passage in a case that the valve body is apart from the valve seat. The biasing means biases the valve body toward the valve seat with a specified biasing force. A flow passage area of the downstream-orifice is smaller than that of a passage upstream of the valve seat.

When the valve body moves apart from the valve seat, the fuel flows into the communication passage. Since the fuel-flow is restricted by the downstream-orifice, the fuel pressure is rapidly accumulated in the inner passage between the valve body and the downstream-orifice. Thus, the differential pressure between upstream and downstream of the valve seat becomes smaller, so that the velocity of the fuel flowing between the valve body and the valve seat is decreased. Thereby, it is restricted that cavitation occurs between the valve body and the valve seat, so that noise and vibration due to the cavitation can be reduced. The cavitation corrosion on the valve body and the valve seat is also restricted. Therefore, the deterioration in sealing performance between the valve body and the valve seat can be restricted, and the pressure holding performance of the constant-residual-pressure valve can be maintained.

In a case that the constant-residual-pressure valve is applied to a fuel-supply system of an internal combustion engine, it is restricted that the fuel pressure in the delivery pipe becomes lower than the specified value and that vapors are generated in the fuel after the engine is turned off. Thereby, a startability of the engine can be improved.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a cross-sectional view showing a constant-residual-pressure valve according to a first embodiment;

FIG. 2 is a schematic diagram showing a fuel supply system of an internal combustion engine to which the constant-residual-pressure valve is applied, according to the first embodiment;

FIG. 3 is a cross-sectional view showing a high-pressure pump provided with the constant-residual-pressure valve according to the first embodiment;

FIG. 4 is a partial cross-sectional view viewed along a direction IV in FIG. 3;

FIG. 5 is an enlarged cross-sectional view showing an essential portion in FIG. 4;

FIG. 6 is a cross-sectional view showing a constant-residual-pressure valve according to a second embodiment;

FIG. 7 is a cross-sectional view showing a constant-residual-pressure valve according to a third embodiment;

FIG. 8 is an enlarged cross-sectional view showing a high-pressure pump provided with the constant-residual-pressure valve according to the fourth embodiment;

FIG. 9 is a cross-sectional view showing a constant-residual-pressure valve according to a fourth embodiment;

FIG. 10 is a cross-sectional view showing a constant-residual-pressure valve according to a fifth embodiment;

FIG. 11 is a cross-sectional view showing a constant-residual-pressure valve according to a sixth embodiment;

FIG. 12 is a cross-sectional view showing a constant-residual-pressure valve according to a seventh embodiment;

FIG. 13 is a cross-sectional view showing a constant-residual-pressure valve according to an eighth embodiment;

FIG. 14 is a plain view showing a valve body of a constant-residual-pressure valve according to an eighth embodiment;

FIG. 15 is a plain view showing a valve body of a constant-residual-pressure valve according to a ninth embodiment;

FIG. 16 is a cross-sectional view showing a constant-residual-pressure valve according to a tenth embodiment;

FIG. 17 is a plain view showing a valve body of constant-residual-pressure valve according to the tenth embodiment;

FIG. 18 is a cross-sectional view showing a constant-residual-pressure valve according to an eleventh embodiment;

FIG. 19 is a plain view showing a valve body of a constant-residual-pressure valve according to the eleventh embodiment;

FIG. 20 is a cross-sectional view showing a constant-residual-pressure valve according to a twelfth embodiment;

FIG. 21 is a cross-sectional view showing a constant-residual-pressure valve according to a thirteenth embodiment;

FIG. 22 is a cross-sectional view taken along a line XXII-XXII in FIG. 21;

FIG. 23 is a schematic diagram showing a fuel supply system to which the constant-residual-pressure valve is applied, according to a fourteenth embodiment;

FIG. 24 is a cross-sectional view showing a constant-residual-pressure valve according to the fourteenth embodiment; and

FIG. 25 is a schematic diagram showing a fuel supply system to which the constant-residual-pressure valve is applied, according to a fifteenth embodiment.

### DETAILED DESCRIPTION OF EMBODIMENTS

Hereafter, embodiments of the present invention will be described hereinafter.

[First Embodiment]

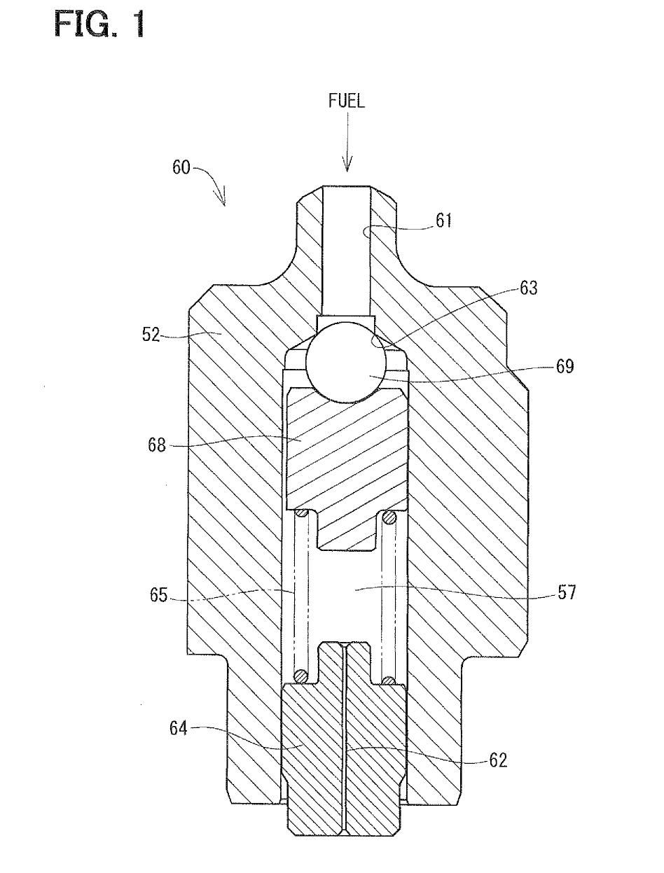

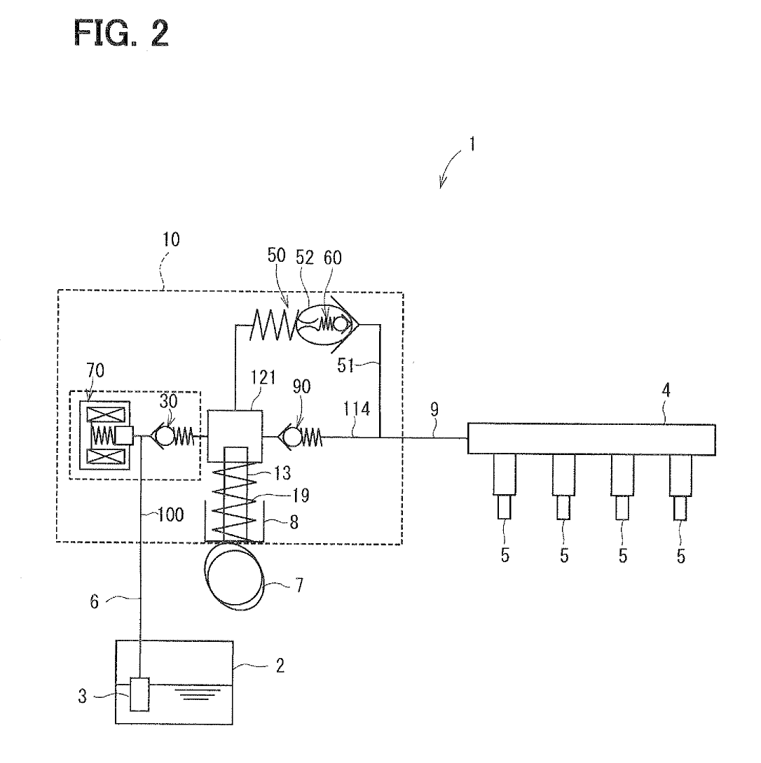

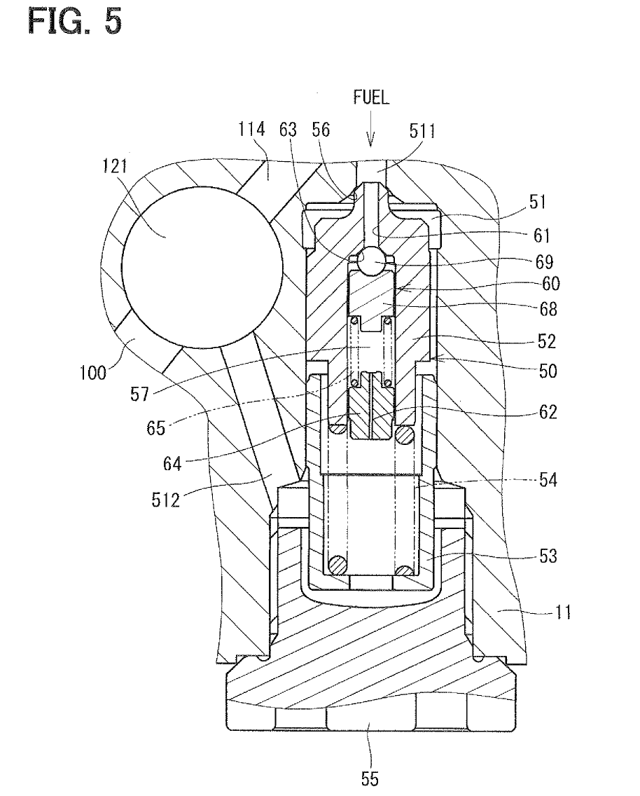

Referring to FIGS. 1 to 5, a first embodiment of the invention will be described. As shown in FIG. 2, a constant-residual-pressure valve 60 is provided to a high-pressure pump 10 which is used in a fuel-supply system 1 of a direct injection engine. In the fuel-supply system 1, a low-pressure pump 3 pumps up fuel from a fuel tank 2. The pumped fuel is introduced into a supply passage 100 of the high-pressure pump 10 through a low-pressure fuel pipe 6. The high-pressure pump 10 has a plunger 13 which axially reciprocates to pressurize the fuel in a pressurization chamber 121. The pressurized fuel is discharged into a discharge passage 114. The pressurized fuel is introduced into a high-pressure fuel pipe 9 and is accumulated in a delivery pipe 4. Then, the high-pressure fuel accumulated in the delivery pipe 4 is injected into each cylinder through a fuel injector 5.

A relief valve 50 is provided in a communication passage 51 which connects the discharge passage 114 to the pressurization chamber 121. The relief valve 50 has a relief valve body 52 in which an inner passage is formed. The constant-residual-pressure valve 60 is disposed in this inner passage. When a differential fuel pressure between the discharge passage 114 and the pressurization chamber 112 exceeds a specified pressure, the constant-residual-pressure valve 60 is opened to allow a fuel flow from the discharge passage 114 to the pressurization chamber 121.

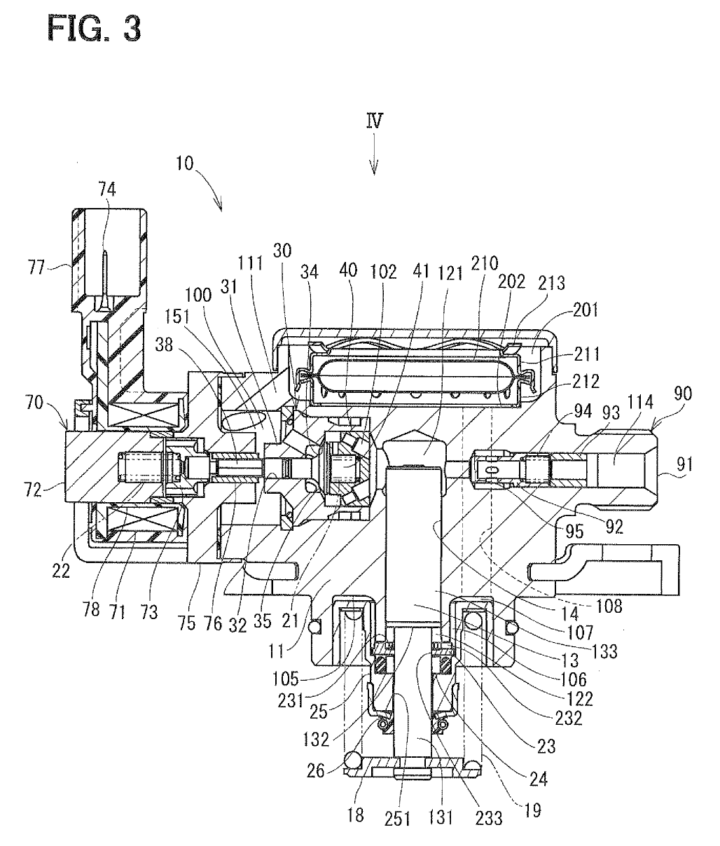

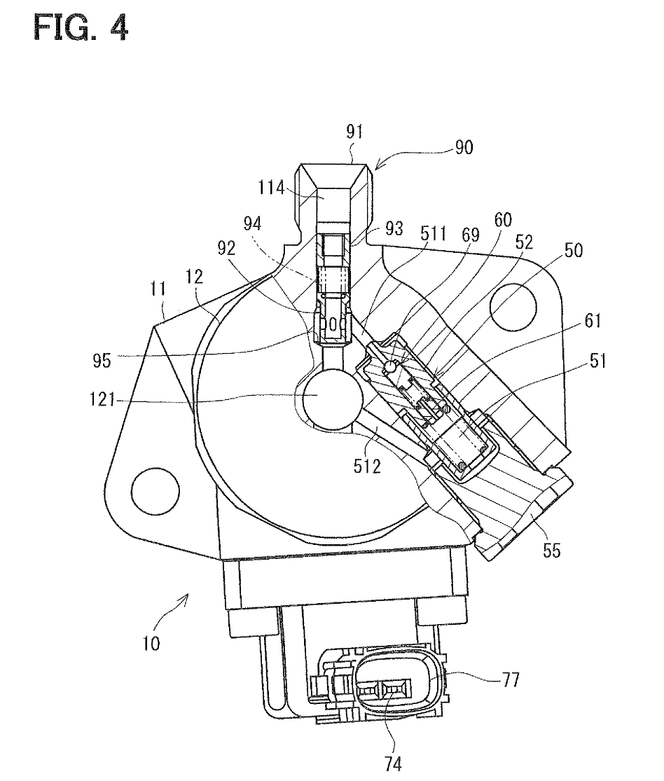

Referring to FIGS. 3 and 4, a configuration of the high-pressure pump 10 will be described in detail. The high-pressure pump 10 is provided with a pump body 11, a plunger 13, a pulsation damper 210, a suction valve portion 30, a discharge valve portion 90, a relief valve 50 and the constant-residual-pressure valve 60. The pump body 11 forms a cylinder 14 therein. A plunger 13 is accommodated in the cylinder 14. The pressurization chamber 121 is defined by one end of the plunger 13 and the cylinder 14. A spring seat 18 is engaged with the other end of the plunger 13. A spring 19 is provided between the spring seat 18 and an oil-seal holder 25. One end of the spring 19 is engaged with the oil-seal holder 25 and the other end is engaged with the spring seat 18 in a condition where the spring 19 is axially compressed. The plunger 13 is in contacted with the camshaft 7 through a tappet 8 shown in FIG. 2. The plunger 13 reciprocates to pressurize the fuel in the pressurization chamber 121.

The pump body 11 forms a damper chamber 201 therein. The damper chamber 201 communicates with a fuel inlet (not shown) through a fuel passage (not shown). This fuel inlet communicates with the fuel tank 2 through the low-pressure fuel pipe 6. Thus, the fuel in the fuel tank 2 is introduced into the damper chamber 201 through the fuel passage and the fuel inlet. The damper chamber 201 accommodates the pulsation damper 210 which reduces fuel pressure pulsation. The pulsation damper 210 is supported by a pair of supporting members 211, 212 in the damper chamber 201. The supporting members 211, 212 are urged toward a concave portion 202 by a wave spring 213.

The suction valve portion 30 includes a valve body 31, a suction valve 35, a stopper 40 and an electromagnetic actuator 70. The pump body 11 has a suction passage 151 which extends perpendicularly relative to a center axis of the cylinder 14. One end of the suction passage 151 communicates with the pressurization chamber 121, and the other end of the suction passage 151 communicates with the damper chamber 201 through an introduction passage 111. The valve body 31 is fixed in the suction passage 151 adjacent to the pressurization chamber 121. A suction valve seat 34 is formed on the valve body 31 adjacent to the pressurization chamber 121. The suction valve 35 slides in a hole 32 formed in the valve body 31. The suction valve 35 has a seal surface which can sit on the suction valve seat 34.

A stopper 40 is fixed on an inner wall surface of the valve body 31 to restrict a movement of the suction valve 35. A volume chamber 41 is defined inside of the stopper 40. A first spring 21 is accommodated in the volume chamber 41. The first spring 21 biases the suction valve 35 toward the suction valve seat 34.

The stopper 40 has a plurality of inclined passages 102 which are inclined relative to an axis of the stopper. The fuel introduced into the suction passage 151 from the damper chamber 201 through the introduction passage 111 flows into the pressurization chamber 121 through the inclined passages 102 when the suction valve 35 is opened.

It should be noted that the supply passage 100 is comprised of a fuel passage between the fuel inlet and the damper chamber 201, the damper chamber 201, the introduction passage 111, the suction passage 151, and the inclined passages 102.

The electromagnetic actuator 70 is comprised of a coil 71, a fixed core 72, a movable core 73 and the like. The coil 71 is wound around a spool 78 made of resign. The fixed core 72 is made of magnetic material and is accommodated inside of the spool 78. The movable core 73 is made of magnetic material and is slidably arranged toward the pressurization chamber 121. A second spring 22 is provided between the fixed core 72 and the movable core 73. The second spring 22 biases the movable core 73 to open the suction valve 35. The biasing force of the second spring 22 is greater than that of the first spring 21. The electromagnetic actuator 70 is attached to the pump body 11 through an attachment member 75. A needle 38 is slidably arranged in a guide cylinder 76 which is formed in the attachment member 75. One end of the needle 38 is connected to the movable core 73 and the other end is in contact with the suction valve 35.

While the coil 71 is not energized, the needle 38 is biased toward the suction valve 35 by the second spring 22 so that the suction valve 35 is opened. When the coil 71 is energized through a terminal 74 of a connector 77, the coil 71 generates magnetic field. Then, magnetic flux flows through the fixed core 72, the movable core 73 and the attachment member 75, whereby the movable core 73 is attracted to the fixed core 72 against the second spring 22. Thereby, the movable core 73 and the needle 38 are moved toward the fixed core 72 so that the suction valve 35 is closed.

The discharge valve portion 90 is comprised of a discharge valve 92, a regulation member 93, a spring 94 and the like. The pump body 11 defines a discharge passage 114 which extends perpendicularly relative to the center axis of the cylinder 14. The discharge passage 114 communicates the pressurization chamber 121 and a fuel outlet 91. The discharge valve 92 is cup-shaped and is slidably accommodated in the discharge passage 114. When the discharge valve 92 sits on a discharge valve seat 95, the discharge passage 114 is closed. When the discharge valve 92 moves away from the discharge valve seat 95, the discharge passage 114 is opened. The regulation member 93 is press-fixed in the discharge passage 114. One end of the spring 94 is engaged with the regulation member 93 and the other end is engaged with the discharge valve 92. The spring 94 biases the discharge valve 92 toward the discharge valve seat 95.

When a biasing force which the discharge valve 92 receives from the pressurization chamber 121 becomes greater than a specified value, the discharge valve 92 moves away from the discharge valve seat 95. Thereby, the fuel in the pressurization chamber 121 is discharged from the fuel outlet 91 through the discharge passage 114. Meanwhile, when a biasing force which the discharge valve 92 receives from the pressurization chamber 121 becomes less than the specified value, the discharge valve 92 sits on the discharge valve seat 95. Thereby, a reverse flow of the fuel from the fuel outlet 91 toward the pressurization chamber 121 is avoided.

A variable volume chamber 122 will be described hereinafter. The plunger 13 has a small-diameter portion 131 and a large-diameter portion 133. A stepped surface 132 is formed between the small-diameter portion 131 and the large-diameter portion 133. A plunger stopper 23 is in contact with an end surface of the pump body 11. The plunger stopper 23 has a through-hole 233 at its center. The small-diameter portion 131 is inserted into the through-hole 233. The plunger stopper 23 has a concave portion 231 and grooves 232 which radially extend from the concave portion 231.

The pump body 11 has an annular concave portion 105. An oil-seal holder 25 is inserted into the annular concave portion 105 of the pump body 11. The oil-seal holder 25 has an aperture 251 through which the small-diameter portion 131 is inserted. The oil-seal holder 25 is fixed on an inner surface of the annular concave portion 105 through the plunger stopper 23 and a seal member 24. The seal member 24 regulates the thickness of the fuel around the small-diameter portion 131 to avoid a fuel leakage. An oil seal 26 is provided to the oil-seal holder 25. The oil seal 26 regulates the thickness of the oil around the small-diameter portion 131 to avoid an oil leakage. The variable volume chamber 122 is defined by the stepped surface 132, the outer wall surface of the small-diameter portion 131, an inner wall surface of the cylinder 14, the concave portion 231 and an annular space surrounded by the seal member 24.

A cylindrical passage 106 and an annular passage 107 are defined between the oil-seal holder 25 and the pump body 11. The cylindrical passage 106 communicates with the grooves 232 of the plunger stopper 23. The annular passage 107 communicates with the damper chamber 201 through a return passage 108 which is formed in the pump body 11. As above, the grooves 232, the cylindrical passage 106, the annular passage 107, and the return passage 108 communicate with each other, whereby the variable volume chamber 122 communicates with the damper chamber 201.

The volume of the variable volume chamber 122 is varied according to the reciprocation of the plunger 13. When the plunger 13 slides up in a metering stroke, the volume of the pressurization chamber 121 is decreased and the volume of the variable volume chamber 122 is increased. At this time, about 60% of the fuel discharged into the damper chamber 201 from the pressurization chamber 121 is suctioned into the variable volume chamber 122 from the damper chamber 201. Thereby, the transfer of the fuel-pressure pulsation is reduced about 60%.

Meanwhile, when the plunger 13 slides down in a suction stroke, the volume of the pressurization chamber 121 is increased and the volume of the variable volume chamber 122 is decreased. About 60% of the fuel suctioned into the pressurization chamber 121 is supplied from the variable volume chamber 122, and about 40% of the fuel is suctioned from the fuel inlet. Thus, a suction efficiency of the fuel to the pressurization chamber 121 is improved.

Referring to FIGS. 1, 4, and 5, the pressure regulating valve will be described hereinafter. The pressure regulating valve is comprised of a relief valve 50 and the constant-residual-pressure valve 60. The pump body 11 has a communication passage 51 which extends perpendicularly relative to the center axis of the cylinder 14. The communication passage 51 is comprised of a first communication passage 511 and a second communication passage 512. A plug 55 closes an opening of the communication passage 51 at an outside wall of the pump body 11. The communication passage 51 fluidly connects the discharge passage 114 and the pressurization chamber 121.

The relief valve 50 is comprised of a relief valve body 52, an adjustment pipe 53, and a relief spring 54. The relief valve body 52 is formed cylindrical and is slidably arranged in the communication passage 51. When the relief valve body 52 sits on a relief-valve seat 56, the communication passage 51 is closed. When the relief valve body 52 moves apart from the relief-valve seat 56, the communication passage 51 is opened. The adjustment pipe 53 is fixed on an inner wall of the pump body 11. One end of the relief spring 54 is engaged with the relief valve body 52, and the other end is engaged with the adjustment pipe 53. The relief valve body 52 is biased toward the relief-valve seat 56 by the relief spring 54. A load of the relief spring 54 is adjusted by a press-insert amount of the adjustment pipe 53.

The constant-residual-pressure valve 60 is comprised of a valve body 69, a supporting member 68, a spring 65 and a spring-stopper 64. These elements are accommodated in an inner passage 57 which is formed in the relief valve body 52. This inner passage 57 is a part of the communication passage 51. The valve body 69 is formed spherically. When the valve body 69 sits on a valve seat 63, the inner passage 57 is closed. When the valve body 69 moves away from the valve seat 63, the inner passage 57 is opened. The supporting member 68 is shaped cylindrical. A supporting end of the member 68 is spherically concaved to support the valve body 69. An outer wall surface of the supporting member 68 is smoothed so that the fuel can flow around the supporting member 68.

A spring-stopper 64 is press-inserted into the inner passage 57. The spring-stopper 64 defines a downstream-orifice 62 therein. A flow passage area of the downstream-orifice 62 is smaller than that of a passage 61 upstream of the valve seat 63. The flow passage area of the downstream-orifice 62 is enough to maintain a pump efficiency of the high-pressure pump 10. That is, when the plunger 13 slides down to reduce the pressure in the pressurization chamber 121, the fuel pressure in the delivery pipe 4 receives less influence from the fuel flowing into the pressurization chamber 121 from the discharge passage 114.

The spring 65 is a compression coil spring. One end of the spring 65 is engaged with the spring-stopper 64, and the other end is engaged with the supporting member 68. The spring 65 biases the supporting member 68 and the valve body 69 toward the valve seat 63. A load of the spring 65 is adjusted according to a press-inserted amount of the spring stopper 64. In the present embodiment, the load of the spring 65 is adjusted in such a manner that the constant-residual-pressure valve 60 is opened when the fuel pressure in the delivery pipe 4 exceeds a specified value. Thus, fuel vapor is less generated in the delivery pipe 4 after the engine is stopped, and the fuel leakage from the fuel injector 5 is restricted.

An operation of the high-pressure pump 10 will be described hereinafter. The high-pressure pump 10 repeatedly performs the suction stroke, the metering stroke, and the pressurization stroke.

(1) Suction Stroke

When the plunger 13 slides down from the top dead center toward the bottom dead center, the pressurization chamber 121 is depressurized. The coil 71 is deenergized, the suction valve 35 is opened, and the supply passage 100 communicates with the pressurization chamber 121. The discharge valve 92 sits on the discharge-valve seat 95 to close the discharge passage 114. Thus, the fuel is suctioned from the supply passage 100 into the pressurization chamber 121. At this moment, the fuel pressure in the discharge passage 114 becomes lower than that in the pressurization chamber 121. A differential pressure is generated between the fuel pressure in the passage 61 and the fuel pressure in the inner passage 57. The valve body 69 moves away from the valve seat 63. Since the fuel flowing between the valve body 69 and the valve seat 63 is restricted by the downstream-orifice 62, the fuel pressure is rapidly accumulated in the inner passage 57 between the valve body 69 and the downstream-orifice 62. Thus, the differential pressure between the passage 61 and the inner passage 57 becomes smaller. Then, the valve body 69 sits on the valve seat 63 by the biasing force of the spring 65.

(2) Metering Stroke

When the plunger 13 slides up from the bottom dead center toward the top dead center, the coil 71 is deenergized and the suction valve 35 is opened for a specified time period. Thus, the low-pressure fuel in the pressurization chamber 121 is returned to the damper chamber 201 through the suction passage 151 and the introduction passage 111.

When the coil 71 is energized in the metering stroke, the coil 71 generates magnetic field. The movable core 73 and the needle 38 are magnetically attracted to the stationary core 72. The suction valve 35 sits on the valve seat 34 to close the supply passage 100. When the supply passage 100 is closed, the metering stroke is terminated. That is, by adjusting the timing at which the coil 71 is energized, the low-pressure fuel quantity returned from the pressurization chamber 121 to the damper chamber 201 is adjusted. Thereby, the quantity of fuel pressurized in the pressurization chamber 121 is determined.

(3) Pressurization Stroke

When the plunger 13 further slides up toward the top dead center with an interruption between the pressurization chamber 121 and the damper chamber 201, the fuel pressure in the pressurization chamber 121 further increases. When the fuel pressure in the pressurization chamber 121 exceeds a specified value, the suction valve 92 is opened against the spring 94 and the fuel pressure of downstream. Thereby, the high-pressure fuel pressurized in the pressurization chamber 121 is discharged from the high-pressure pump 10 through the discharge passage 114. When the fuel pressure in the pressurization chamber 121 is increased to open the discharge valve 92, the fuel pressure in the discharge passage 114 is substantially equal to the fuel pressure in the pressurization chamber 121. The fuel pressure in the passage 61 is substantially equal to the fuel pressure downstream of the downstream-orifice 62. Thus, the valve body 69 sits on the valve seat 63 by receiving a biasing force of the spring 65.

When the plunger 13 reaches the top dead center, the coil 71 is deenergized and the suction valve 35 is opened again. Then, the plunger 13 slides down again to perform the suction stroke. The above suction stroke, the metering stroke and the pressurizing stroke are conducted repeatedly, so that the high-pressure pump 10 pressurizes and discharges the fuel. The valve body 69 of the constant-residual-pressure valve 60 repeats opening and closing in the suction stroke and the pressurization stroke.

In the present embodiment, since the constant-residual-pressure valve 60 has the downstream-orifice 62 downstream of the valve body 69, the fuel pressure is rapidly accumulated in the inner passage 57 between the valve body 69 and the downstream-orifice 62. Thus, the differential pressure between the passage 61 and the inner passage 57 becomes smaller, so that the velocity of the fuel flowing between the valve body 69 and the valve seat 63 is decreased. Thereby, it is restricted that cavitation occurs between the valve body 69 and the valve seat 63, so that noise and vibration due to the cavitation can be reduced. The cavitation corrosion on the valve body 69 and the valve seat 63 is also restricted. Therefore, the deterioration in sealing performance between the valve body 69 and the valve seat 63 can be restricted, and the pressure holding performance of the constant-residual-pressure valve 60 can be maintained. In the fuel-supply system 1 of the present embodiment, it is restricted that the fuel pressure in the delivery pipe 4 becomes lower than the specified value and that vapors are generated in the fuel. Thereby, the startability of the engine can be improved.

In the present embodiment, the downstream-orifice 62 is formed in the spring stopper 64. The spring stopper 64 is made of material which has received no heat treatment. Thus, the downstream-orifice 62 is easily formed in the spring stopper 64 and the flow passage area of the downstream-orifice 62 can be easily adjusted. The pump efficiency of the high-pressure pump can be surely maintained.

[Second Embodiment]

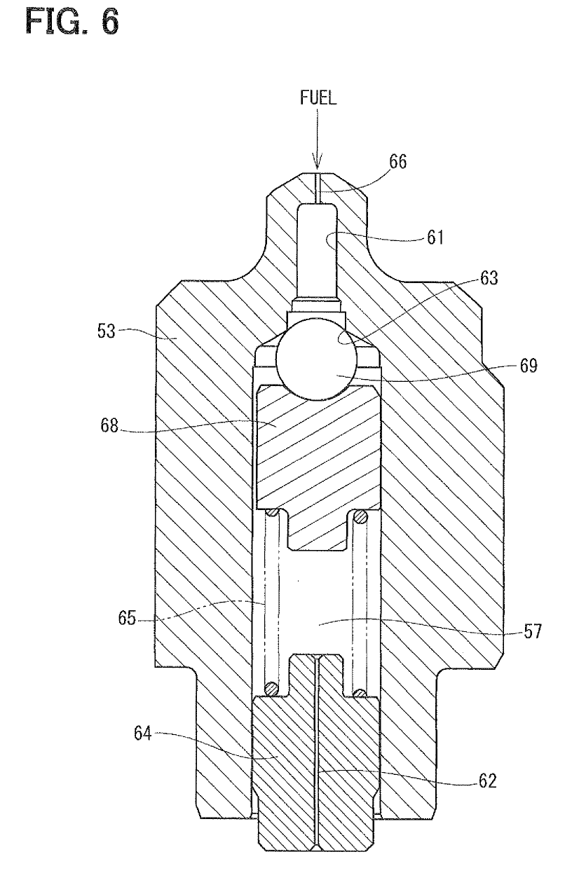

Referring to FIG. 6, a second embodiment of the constant-residual-pressure valve will be described. The constant-residual-pressure valve includes an upstream-orifice 66 in the passage 61 upstream of the valve seat 63. A flow passage area of the upstream-orifice 62 is greater than that of the downstream-orifice 62. The flow passage areas of the downstream-orifice 62 and the upstream-orifice 66 are enough to maintain the pump efficiency of the high-pressure pump 10. That is, when the plunger 13 slides down to reduce the pressure in the pressurization chamber 121, the fuel pressure in the delivery pipe 4 receives less influence from the fuel flowing into the pressurization chamber 121 from the discharge passage 114.

When the valve body 69 moves away from the valve seat 63, the fuel pressure is rapidly accumulated in the inner passage 57 between the valve body 69 and the downstream-orifice 62. Thus, the differential pressure between the passage 61 and the inner passage 57 becomes smaller, so that the velocity of the fuel flowing between the valve body 69 and the valve seat 63 is decreased. Thereby, it is restricted that cavitation occurs between the valve body 69 and the valve seat 63, so that noise and vibration due to the cavitation can be reduced. The cavitation corrosion on the valve body 69 and the valve seat 63 is also restricted. The upstream-orifice 66 reduces the transmission of a fuel pressure wave generated in the discharge passage 114 to the valve body 69 and the spring 65. The vibration of the valve body 69 and the spring 65 due to the fuel pressure wave can be restricted. As the result, the pressure holding performance of the constant-residual-pressure valve can be maintained.

[Third Embodiment]

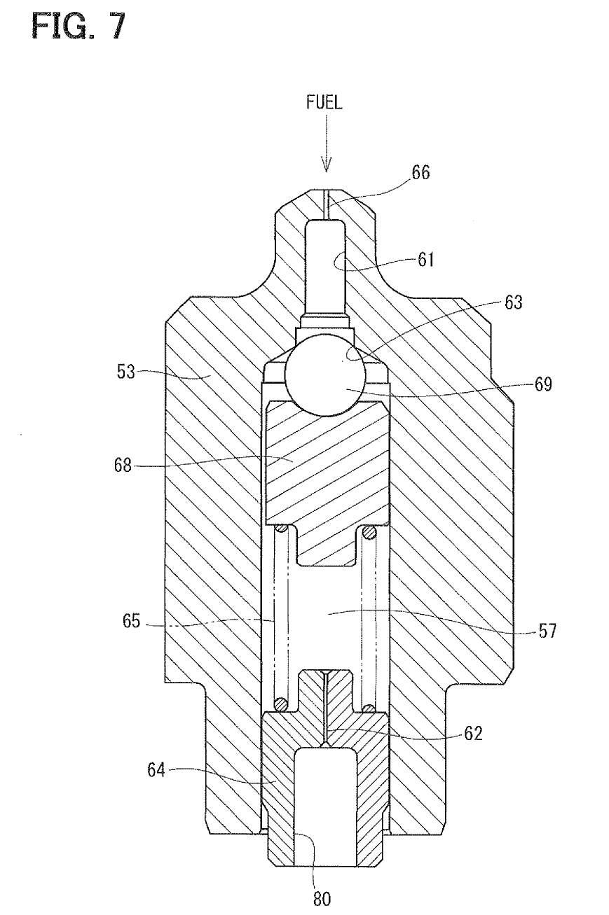

Referring to FIG. 7, a third embodiment of the constant-residual-pressure valve will be described. The spring-stopper 64 has a concave portion 80 downstream of the downstream-orifice 62. Since the velocity of the fuel flowing through the downstream-orifice 62 is high, it is likely that the cavitation is generated around an outlet of the downstream-orifice 62. However, since the flow passage area of the concave portion 80 is greater than that of the downstream-orifice 62, the velocity of the fuel flowing through the concave portion 80 is decreased. Thus, in the present embodiment, the cavitation generated in the downstream-orifice 62 can be reduced in the concave portion 80. It is restricted that the cavitation corrosion is generated on the relief spring 54 and the adjustment pipe 53. Besides, by forming the concave portion 80 in the spring-stopper 64, the length of the downstream-orifice 62 is made shorter. The manufacturing cost of the downstream-orifice 62 can be reduced.

[Fourth Embodiment]

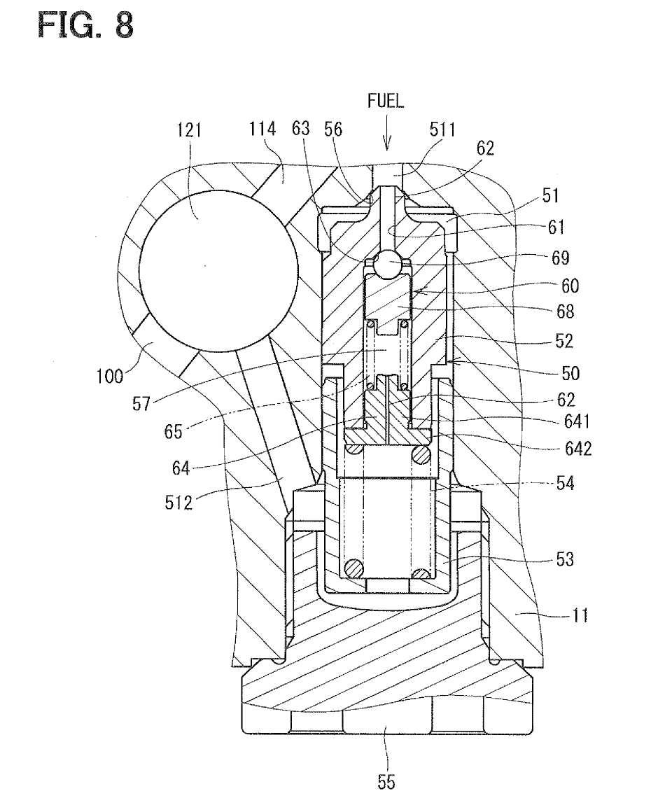

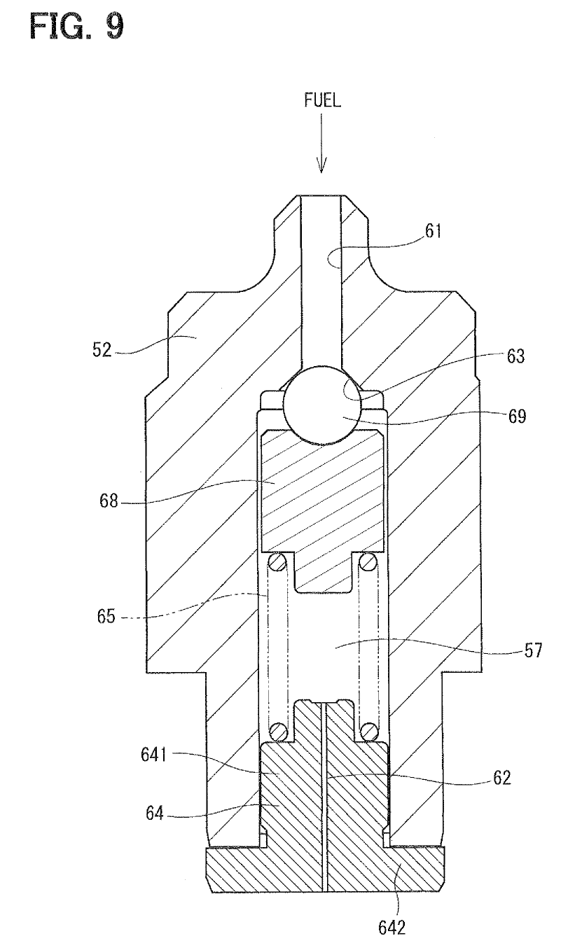

Referring to FIGS. 8 and 9, a fourth embodiment of the constant-residual-pressure valve will be described. The spring-stopper 64 has a cylindrical portion 641 and a flange portion 642. The cylindrical portion 641 is press-inserted into the inner passage 57. The flange portion 642 radially outwardly extends from an outer surface of the cylindrical portion 641. The flange portion 642 is in contact with an axial end portion of the relief valve body 52. One end of the relief spring 54 is engaged with the adjustment pipe 53 and the other end is in contact with the flange portion 642. The relief spring 54 urges the flange portion 642 toward the axial end portion of the relief valve body 52. In the present embodiment, a load of press-inserting the cylindrical portion 641 into the inner passage 57 can be made smaller. Thus, it is avoided that the relief valve body 52 is damaged due to the press-insertion. Further, since the press-inserting load is made smaller, the manufacturing accuracy of the downstream-orifice 62 can be improved.

[Fifth Embodiment]

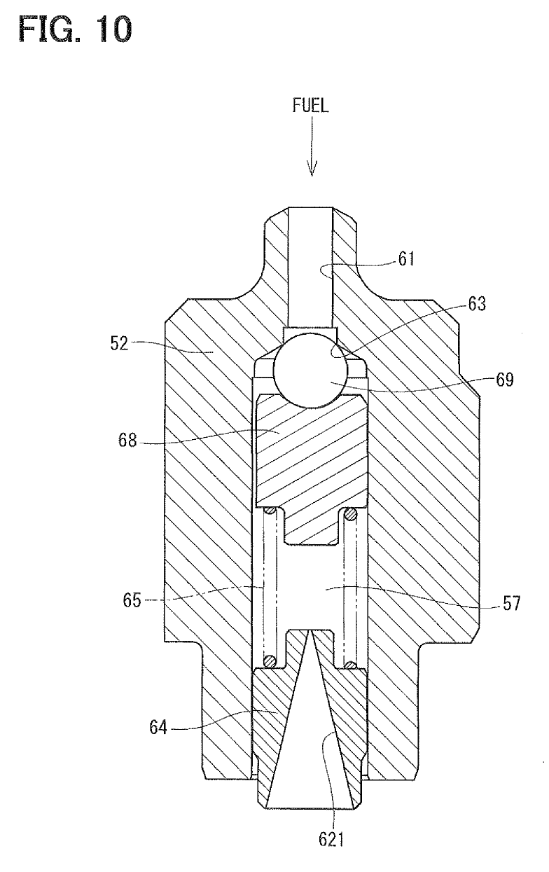

Referring to FIG. 10, a fifth embodiment of the constant-residual-pressure valve will be described. In the fifth embodiment, the downstream-orifice 621 has a tapered shape. Its upstream flow passage area is greater than a downstream flow passage area. Since the velocity of the fuel flowing through the downstream-orifice 621 is decreased, the cavitation bubbles can be reduced in the downstream-orifice 62. Thus, it is restricted that the cavitation corrosion is generated on the relief spring 54 and the adjustment pipe 53.

[Sixth Embodiment]

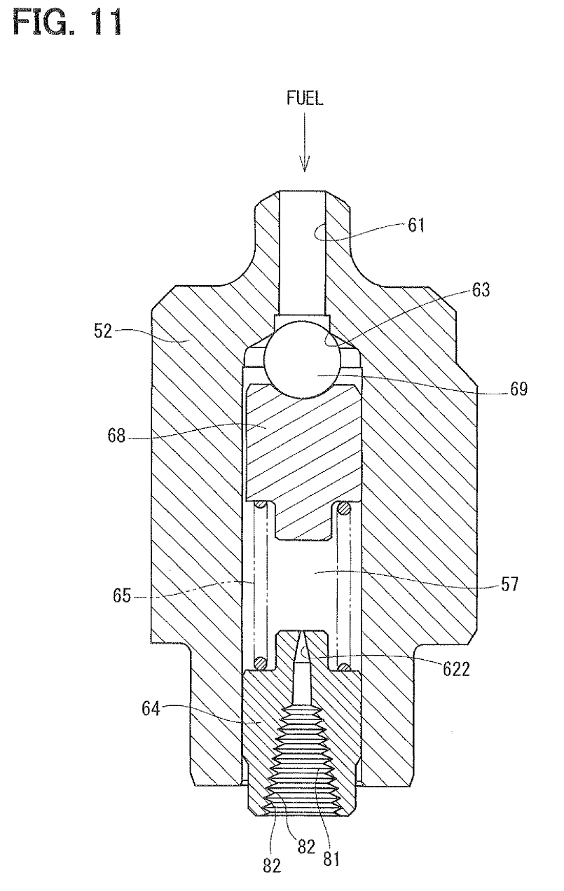

Referring to FIG. 11, a sixth embodiment of the constant-residual-pressure valve will be described. The spring-stopper 64 has a downstream-orifice 622 and a concave portion 81. The downstream-orifice 622 has a tapered shape in order to reduce the cavitation. Also, the concave portion 81 has a tapered shape. Further, the concave portion 81 has a plurality of ring-shaped protrusions 82 which protrude inward from the inner wall surface of the concave portion 81. The plurality of ring-shaped protrusions increase the flow resistance in the concave portion 81, so that the velocity of the fuel flowing through the concave portion 81 is decreased. Thus, it can be restricted that the cavitation bubbles generated in the downstream-orifice 622 flow out downstream of the spring-stopper 64.

[Seventh Embodiment]

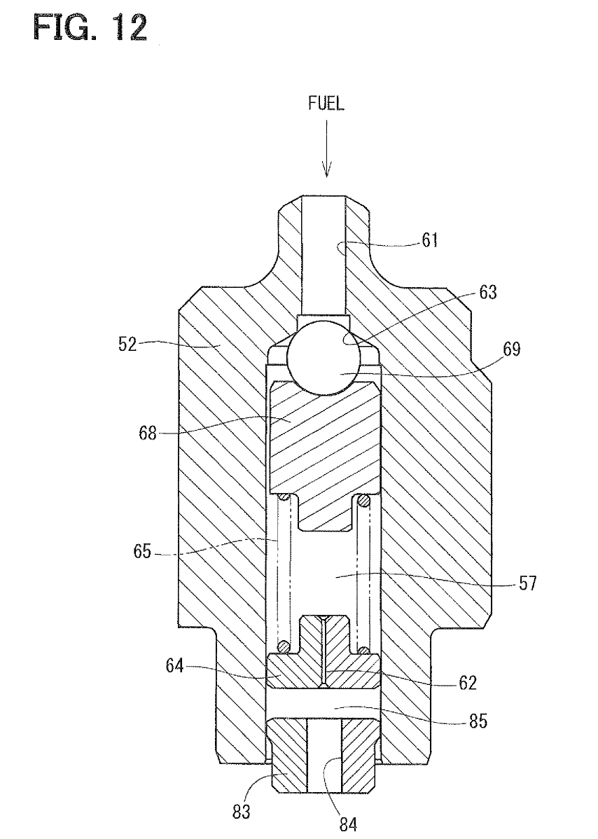

Referring to FIG. 12, a seventh embodiment of the constant-residual-pressure valve will be described. In the seventh embodiment, a passage member 83 is provided downstream of the spring-stopper 64. The passage member 83 has an axial passage 84 and is press-inserted into the inner passage 57. The passage member 83 and the spring-stopper 64 are arranged in such a manner that a fuel space 85 is defined therebetween. The velocity of the fuel flowing from the downstream-orifice 62 toward the fuel space 85 is decreased in the fuel space 85. The cavitation bubbles generated in the downstream-orifice 62 is reduced in the fuel space 85. Thus, it can be restricted that the cavitation bubbles generated in the downstream-orifice 622 flow into the axial passage 84.

[Eighth Embodiment]

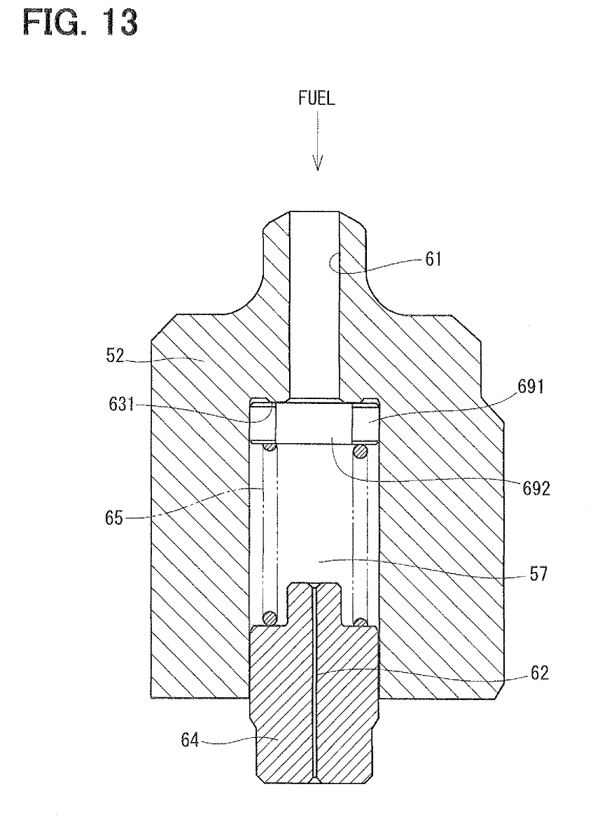

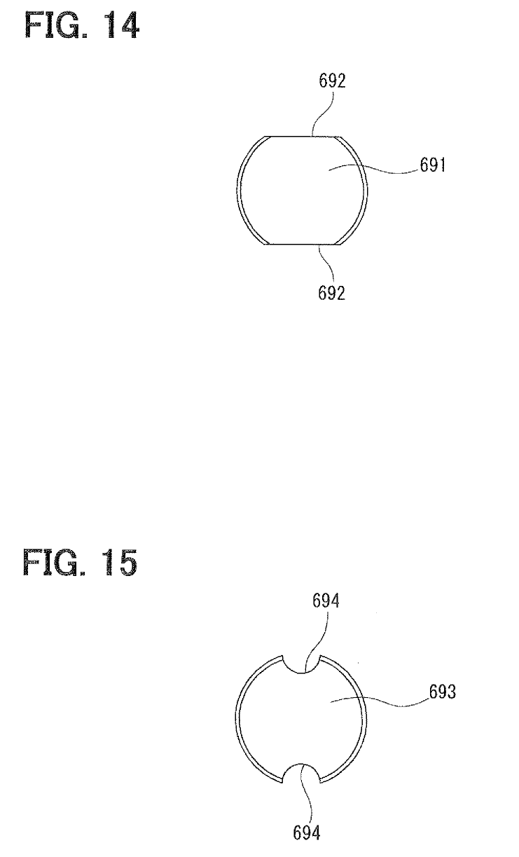

Referring to FIGS. 13 and 14, an eighth embodiment of the constant-residual-pressure valve will be described. FIG. 14 is a plain view showing a valve body of the constant-residual-pressure valve. In the eighth embodiment, the valve body is a flat-shaped valve 691. The flat-shaped valve 691 has a pair of chamfered portions 692. The fuel can flow through clearances between the chamfered portions 692 and the inner passage 57. When the flat-shaped valve 691 sits on a valve seat 631, the passage 61 is closed. A flow passage area of the passage 61 is greater than that of the downstream-orifice 62. The flat-shaped valve 691 receives pressure waves generated in discharged fuel of the high-pressure pump 10, whereby the lift quantity of the flat-shaped valve 691 is made larger. In the present embodiment, it is less likely that foreign matters contained in the fuel are accumulated between the valve seat 631 and the flat-shaped valve 691. Thus, the pressure holding performance can be maintained. Compared to the sphere valve body, the axial height of the valve body can be reduced. The axial size of the constant-residual-pressure valve can be made smaller.

[Ninth Embodiment]

Referring to FIG. 15, a ninth embodiment of the constant-residual-pressure valve will be described. FIG. 15 is a plain view showing a valve body of the constant-residual-pressure valve. Also in the ninth embodiment, the valve body is a flat-shaped valve 693. The flat-shaped valve 693 has a pair of curved chamfered portions 694. The fuel can flow through clearances between the curved chamfered portions 694 and the inner passage 57. Similar to the eighth embodiment, the axial size of the constant-residual-pressure valve can be made smaller.

[Tenth Embodiment]

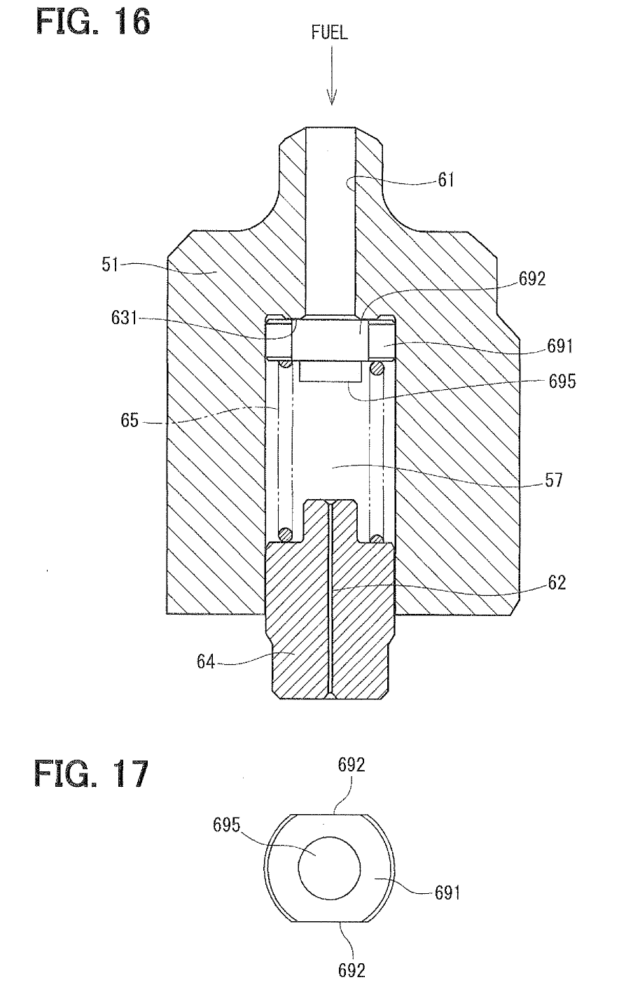

Referring to FIGS. 16 and 17, a tenth embodiment of the constant-residual-pressure valve will be described. FIG. 14 is a plain view showing a valve body 691 of the constant-residual-pressure valve. The tenth embodiment is a modification of the eighth embodiment shown in FIG. 13. In the tenth embodiment, the valve body 691 is a flat-shaped valve having a spring-guide portion 695. The spring-guide portion 695 prevents a positional deviation between the spring 65 and the flat-shaped valve 691 in a radial direction. Thereby, the load of the spring 65 is uniformly applied to the flat-shaped valve 691, so that the sealing between the flat-shaped valve 691 and the valve seat 631 is ensured. The pressure-holding performance of the constant-residual-pressure valve can be enhanced.

[Eleventh Embodiment]

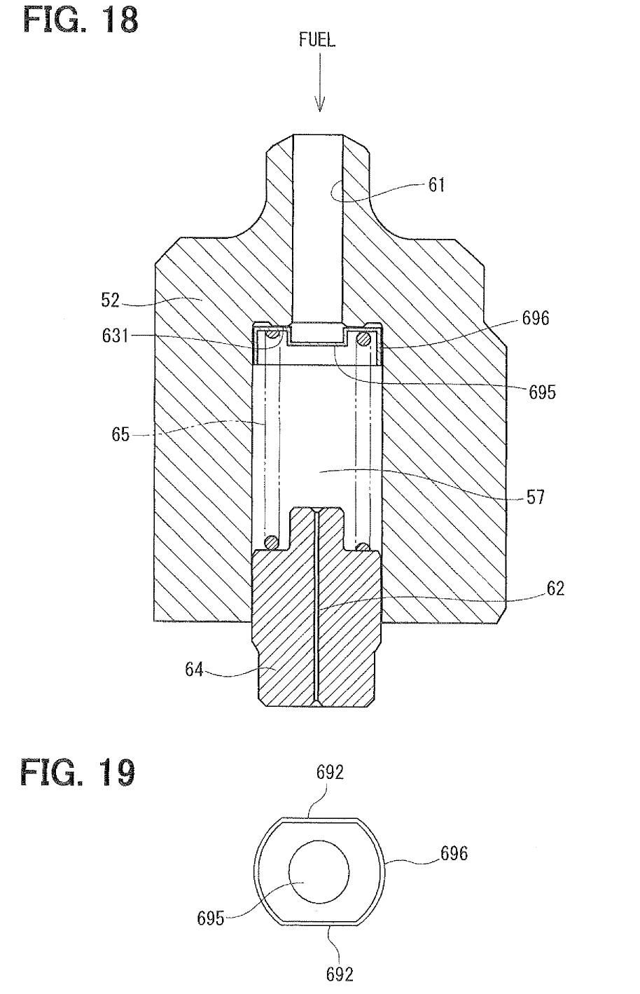

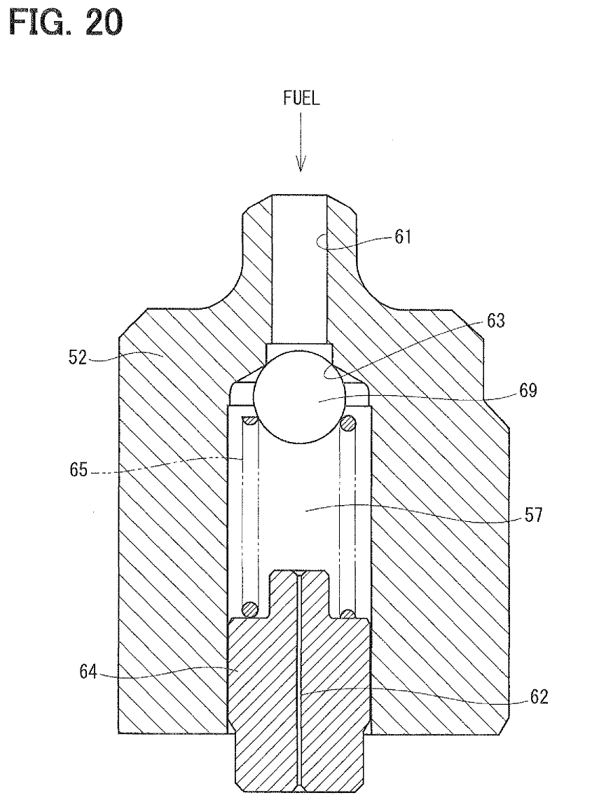

Referring to FIGS. 18 and 19, an eleventh embodiment of the constant-residual-pressure valve will be described. FIG. 19 is a plain view showing a flat-shaped valve 696 of the constant-residual-pressure valve. In the eleventh embodiment, the flat-shaped valve 696 is formed by performing press working of sheet metal. The flat-shaped valve 696 can be made thinner and a contact point between the spring 65 and the flat-shaped valve 696 comes close to the valve seat 631. Thus, the axial size of the constant-residual-pressure valve can be made smaller. Also, the weight of the constant-residual-pressure valve can be reduced.

[Twelfth Embodiment]

Referring to FIG. 20, a twelfth embodiment of the constant-residual-pressure valve will be described. One end of the spring 65 is engaged with the spring-stopper 64, and the other end is directly engaged with the spherical valve body 69. Since a supporting member between the valve body 69 and the spring 65 is unnecessary, the configuration of the constant-residual-pressure valve can be made simple. Also, the axial size of the constant-residual-pressure valve can be made smaller.

[Thirteenth Embodiment]

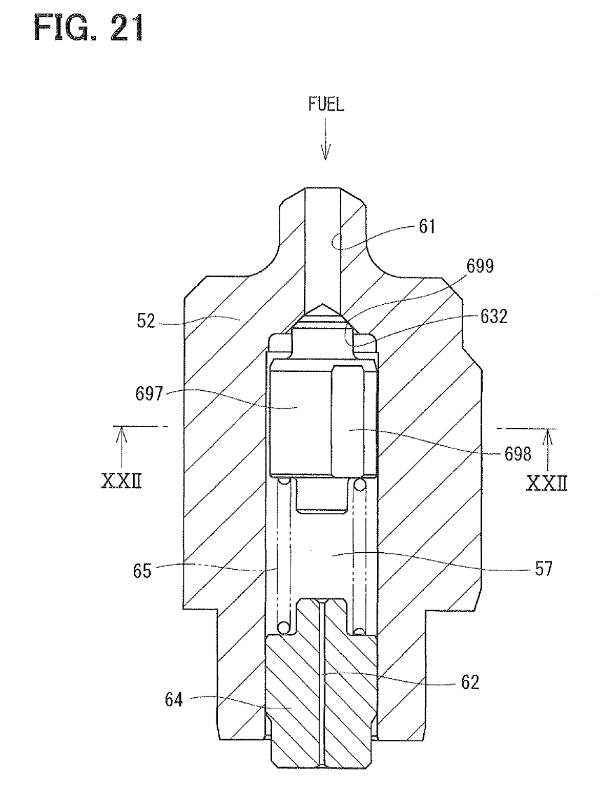

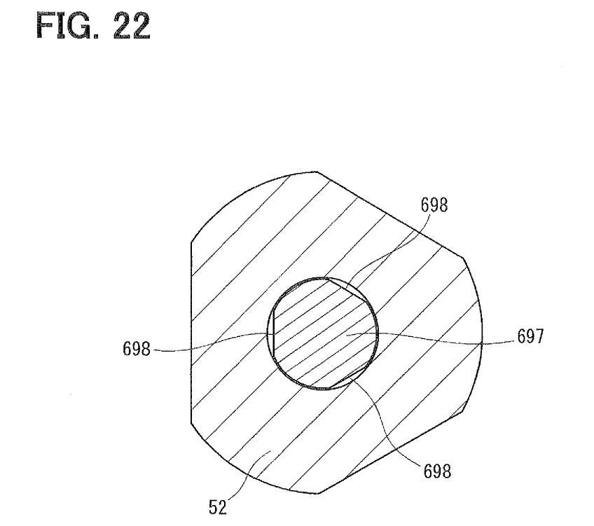

Referring to FIGS. 21 and 22, a thirteenth embodiment of the constant-residual-pressure valve will be described. In the thirteenth embodiment, the valve body is a needle valve 697. The needle valve 697 has three chamfered portions 698. The fuel can flow through clearances between the chamfered portions 698 and the inner passage 57. The needle valve 697 has a conical seal portion 699 which stably sits on the valve seat 632. As the result, the pressure holding performance of the constant-residual-pressure valve can be enhanced.

[Fourteenth Embodiment]

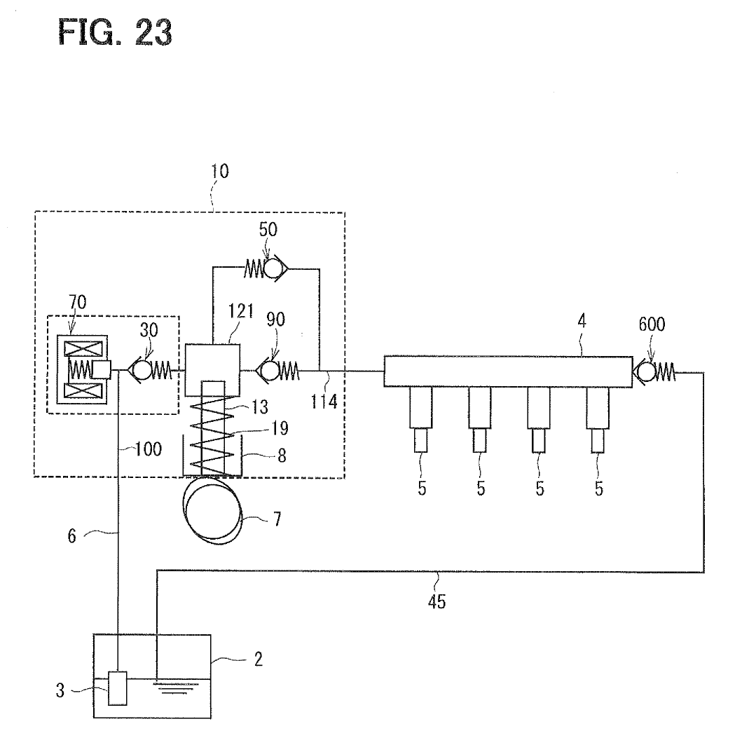

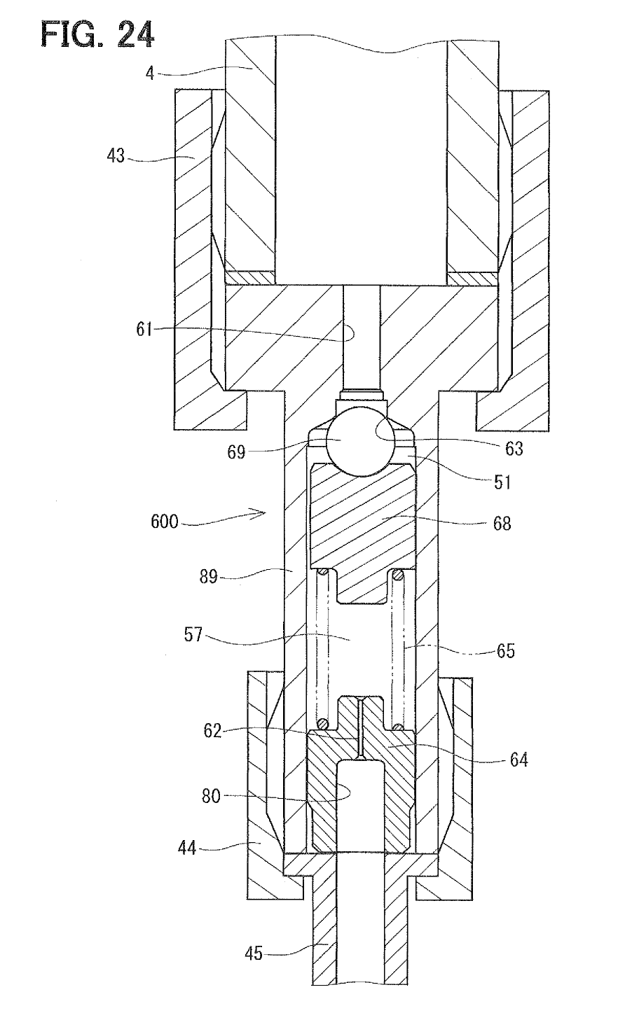

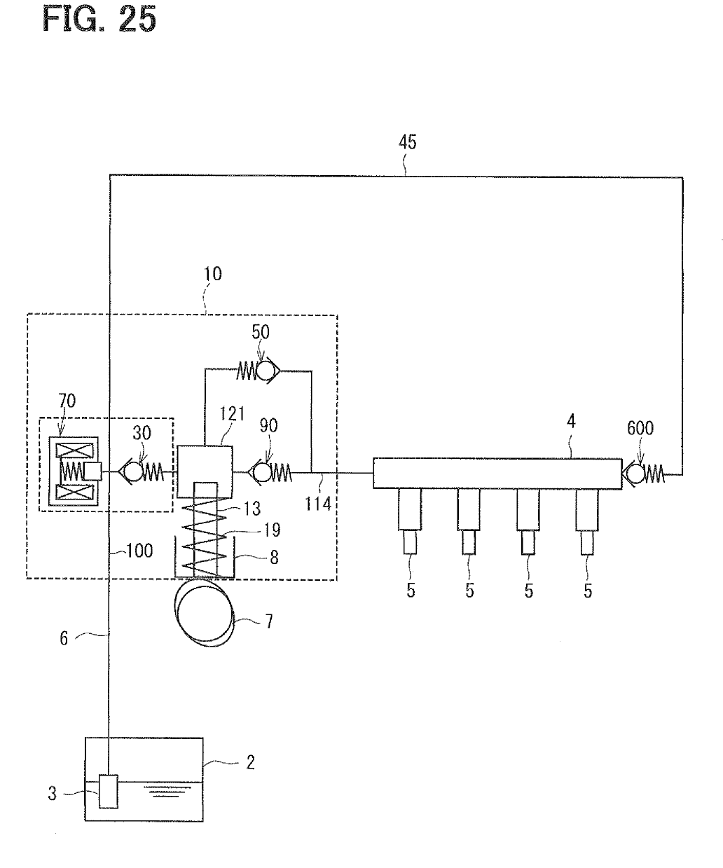

Referring to FIGS. 23 and 24, a fourteenth embodiment of the constant-residual-pressure valve will be described. In the fourteenth embodiment, the constant-residual-pressure valve 600 is provided to an end portion of the delivery pipe 4. The return pipe 45 fluidly connects the constant-residual-pressure valve 600 and the fuel tank 2. The constant-residual-pressure valve 600 has a housing 89 which defines a communication passage 51. The valve body 69, the supporting member 68, the spring 65, and the spring stopper 64 are accommodated in the communication passage 51. The spring-stopper 64 defines the downstream-orifice 62 and the concave portion 80 therein. One end of the housing 89 is connected to the delivery pipe 4 by a first nut 43 and the other end is connected to the return pipe 45 by a second nut 44. Also in the present embodiment, since the constant-residual-pressure valve 600 has the downstream-orifice 62 downstream of the valve body 69, the fuel pressure is rapidly accumulated in the inner passage 57 between the valve body 69 and the downstream-orifice 62. Thus, the differential pressure between the passage 61 and the inner passage 57 becomes smaller, so that the velocity of the fuel flowing between the valve body 69 and the valve seat 63 is decreased. Thereby, it is restricted that cavitation occurs between the valve body 69 and the valve seat 63, so that noise and vibration due to the cavitation can be reduced. The cavitation corrosion on the valve body 69 and the valve seat 63 is also restricted. Therefore, the deterioration in sealing performance between the valve body 69 and the valve seat 69 can be restricted, and the pressure holding performance of the constant-residual-pressure valve 600 can be maintained.

[Fifteenth Embodiment]

Referring to FIG. 25, a fifteenth embodiment of the constant-residual-pressure valve will be described. Also, in the fifteenth embodiment, the constant-residual-pressure valve 600 is provided to an end portion of the delivery pipe 4. One end of the return pipe 45 is connected to the constant-residual-pressure valve 600 and the other end is connected to a supply passage 100 of the high-pressure pump 10. Thereby, it is restricted that cavitation occurs between the valve body 69 and the valve seat 63, so that noise and vibration due to the cavitation can be reduced. The cavitation corrosion on the valve body 69 and the valve seat 63 is also restricted. As the result, the pressure holding performance of the constant-residual-pressure valve 600 can be maintained. The other end of the return pipe 45 may be connected to a low-pressure fuel pipe 6 which connects the high-pressure pump 10 and the fuel tank 2.

[Other Embodiment]

In the first embodiment, the constant-residual-pressure valve is provided in the inner passage 57 formed in the relief valve body 52. However, the constant-residual-pressure valve can be arranged in a passage which is defined in the discharge valve 92. In this case, the passage in the discharge valve 92 corresponds to a communication passage.

Alternatively, the communication passage is defined in the pump body and the constant-residual-pressure valve can be arranged in this communication passage.

In the above embodiments, a compression coil spring 65 is used for biasing the valve body toward the valve seat. Instead of the compression coil, a coned disk spring or a leaf spring can be used for biasing the valve body to the valve seat. The present invention is not limited to the embodiments mentioned above, and can be applied to various embodiments by combining each embodiment.

What is claimed is:

1. A constant-residual-pressure valve disposed in a communication passage connecting a high-pressure fuel passage through which pressurized fuel flows with a low-pressure fuel passage through which the fuel flows toward a high-pressure pump, the constant-residual-pressure valve comprising:
a valve body capable of sitting on a valve seat formed on an inner wall surface of the communication passage, the valve body prohibiting a fuel-flow from the low-pressure fuel passage to the high-pressure fuel passage in a case that the valve body sits on the valve seat, the valve body allowing a fuel-flow from the high-pressure fuel passage to the low-pressure fuel passage in a case that the valve body is apart from the valve seat;
a biasing means for biasing the valve body toward the valve seat with a specified biasing force; and
a downstream-orifice provided downstream of the valve seat, the downstream-orifice having a flow passing area which is smaller than that of a passage upstream of the valve seat.

2. A constant-residual-pressure valve according to claim 1, further comprising
an upstream-orifice provided in a passage upstream of the valve seat, wherein
a flow passage area of the downstream-orifice is smaller than that of the upstream-orifice.

3. A constant-residual-pressure valve according to claim 1, wherein
the flow passage areas of the downstream-orifice and the upstream-orifice are defined in such a manner as to maintain a pump efficiency of the high-pressure pump.

4. A constant-residual-pressure valve according to claim 1, further comprising
an engagement member with which a downstream end of the biasing member is engaged, wherein
the downstream-orifice is formed in the engagement member.

5. A constant-residual-pressure valve according to claim 4, wherein
the engagement member has a concave portion of which flow passage are is larger than that of the downstream-orifice, and
the concave portion is located downstream of the downstream-orifice.

6. A constant-residual-pressure valve according to claim 4, wherein
the downstream-orifice is tapered in such a manner that the flow passage area is gradually increased from upstream to downstream.

7. A constant-residual-pressure valve according to claim 5, wherein
the concave portion is tapered in such a manner that its flow passage area is gradually increased from downstream to upstream, and the concave portion has a protrusion which protrudes radially inward from an inner surface of the concave portion.

8. A constant-residual-pressure valve according to claim 4, further comprising a passage member having an axial passage through which the fuel flows, wherein the passage member is arranged downstream of the engagement member in such a manner as to define a fuel space therebetween in order to reduce cavitation which occurs in the downstream-orifice.

9. A constant-residual-pressure valve according to claim 1, wherein
the valve body is a flat-shaped valve.

10. A constant-residual-pressure valve according to claim 1, wherein
the biasing means has an upstream end which is directly engaged with the valve body.

11. A pressure regulating valve disposed in a communication passage connecting a high-pressure fuel passage through which pressurized fuel flows with a low-pressure fuel passage through which the fuel flows toward a high-pressure pump, the pressure regulating valve comprising:
a relief-valve body capable of sitting on a relief-valve seat formed on an inner wall surface of the communication passage, the relief-valve body prohibiting a fuel-flow from the low-pressure fuel passage to the high-pressure fuel passage in a case that the relief-valve body sits on the relief-valve seat, the relief-valve body allowing a fuel-flow from the high-pressure fuel passage to the low-pressure fuel passage in a case that the relief-valve body is apart from the relief-valve seat;
a relief spring for biasing the relief-valve body toward the relief-valve seat with a specified biasing force; and
a constant-residual-pressure valve according to claim 4, wherein
the constant-residual-pressure valve is disposed in an inner passage formed in the relief-valve body,
the engagement member includes a cylindrical portion press-inserted into the inner passage and a flange portion radially outwardly extends from an outer surface of the cylindrical portion to be in contact with an axial end portion of the relief-valve body, and
the flange portion is biased toward the relief-valve body by the relief spring.
